(19) United States
(12) Patent Application Publication
(10) Pub. No.: US 2023/0019101 A1
(43) Pub. Date: Jan. 19, 2023

(54) OPERATION METHOD OF THE NON-UNIFORM MEMORY ACCESS SYSTEM

(71) Applicants: RESEARCH & BUSINESS FOUNDATION SUNGKYUNKWAN UNIVERSITY, Suwon-si (KR); High Performance Computins Research Center, Suwon-si (KR)

(72) Inventors: Jinkyu JEONG, Seoul (KR); Jaehyun SONG, Seoul (KR)

(73) Assignees: RESEARCH & BUSINESS FOUNDATION SUNGKYUNKWAN UNIVERSITY, Suwon-si (KR); High Performance Computins Research Center, Suwon-si (KR)

(21) Appl. No.: 17/866,668

(22) Filed: Jul. 18, 2022

(30) Foreign Application Priority Data
Jul. 16, 2021 (KR) 10-2021-0093179

(51) Int. Cl. G06F 9/48; G06F 9/50; G06F 9/54

(52) U.S. Cl. CPC G06F 9/4887; G06F 9/5016; G06F 9/544

(57) ABSTRACT

Provided is an operation method of a NUMA system, which includes: designating a page scan range including a plurality of pages; identifying a detour value for each of the plurality of pages; determining whether a detour value of a current target scan page is the same as the reference detour value; and releasing a connection of the current target scan page from the page table when determining that the detour value of the current target scan page is the same as the reference detour value.

### CROSS-REFERENCE TO RELATED APPLICATIONS

This application claims the priority of Korean Patent Application No. 10-2021-0093179 filed on Jul. 16, 2021, in the Korean Intellectual Property Office, the disclosure of which is incorporated herein by reference.

### BACKGROUND

### Field

The present disclosure relates to an operation method of a non-uniform memory access (NUMA) system, and more particularly, to an operation method of a NUMA system, which can maximize a local memory access ratio of an application based on memory access pattern profiling which runs with minimized operating system interference for an application performing a multi-thread parallel computing operation running on a NUMA environment.

### Description of the Related Art

According to a development trend of a processor, the performance of a single thread is stagnant in 2008, but the technology development that increases the number of cores is increasing.

In a current server level, products are released, which are mounted with 20 and 60 cores and up to 120 cores.

In a current server, there is a trend in using a non-uniform memory access (NUMA) structure having individual memories because the bandwidth of the memory controller has limitation and an extension of additional hardware is easy as compared with an existing symmetric parallel processing (SM) structure. Therefore, servers have multiple NUMA nodes in case of requirements for high performance.

A node in the NUMA structure is constituted by a local memory and multiple cores, and each node is connected to another node through a high-speed interconnect such as Intel Quick Pass interconnect (QPI).

All memory accesses in the local node have the same characteristic as single CPU computers, while remote memory accesses positioned in another NUMA node induce an additional delay. As a result, a thread running on NUMA systems experiences a performance difference depending on a location of a thread. Further, the amount of added delays varies depending on the number of accessed hops. This means that the amount of delays of the remote memory access also increases in proportion to the distance between the nodes.

In NUMA systems, an operating system scheduler performs the task of uniformly maintaining the load of cores between the nodes, and operates by arranging the thread running on all cores in case of a multi-thread parallel computing application.

When a Daemon process or a kernel thread instantaneously operates in a specific core, a core load imbalance occurs between the nodes. In this case, the scheduler rearranges the thread of the parallel computing application in another node, and this changes the local memory access ratio of the thread. As a result, a performance deviation for each execution of the multi-thread parallel computing application which operates in the NUMA structure is generated.

Further, Auto-NUMA which is a representative NUMA resource management technique for increasing the local memory access ratio performs thread and page rearrangement thorough page access profiling by incurring a periodic page fault. The Auto-NUMA makes all threads sharing a page be included in one group and arranges the threads in a group in one NUMA node.

As a result, the core load imbalance between the nodes occurs and a policy collision with the CPU scheduler occurs, and there is a problem in that unnecessary thread and page movement between the nodes occurs.

In recent years, a research for improving such a phenomenon has been conducted.

### SUMMARY

An object of the present disclosure is to provide an operation method of a NUMA system, which may maximize a local memory access ratio of an application based on memory access pattern profiling which runs with minimized operating system interference for an application performing a multi-thread parallel computing operation running on a NUMA environment.

The objects of the present disclosure are not limited to the above-mentioned objects, and other objects and advantages of the present disclosure that are not mentioned may be understood by the following description, and will be more clearly understood by embodiments of the present disclosure. Further, it will be readily appreciated that the objects and advantages of the present disclosure may be realized by means and combinations shown in the claims.

According to an aspect of the present disclosure, there is provided an operation method of a NUMA system, which may include: designating a page scan range including a plurality of pages; identifying a detour value for each of the plurality of pages; determining whether a detour value of a current target scan page is a reference detour value; releasing a connection of the current target scan page from a page table when determining that the detour value of the current target scan page is the same as the reference detour value.

The operation method of an NUMA system may further include determining whether the page scan range or more is scanned, before identifying the detour value.

When checking the detour value, a detour value that increases or decreases according to whether the state of the current target scan page is changed, which is determined by the access pattern of the threads may be identified.

The operation method of a NUMA system may further include scanning a subsequent target scan page of the current target scan page, after the release of the connection from the page to the page table.

The operation method of a NUMA system may further include determining whether the page state of the current target scan page is a thread private state accessed only by one thread when the detour value is not the same as the reference detour value.

The operation method of a NUMA system may further include: determining whether the current target scan page and the thread are positioned in the same NUMA node when the page state is the thread private state; migrating the current target scan page to a NUMA node in which the thread is executed when the current target scan page and the thread are not positioned in the same NUMA node.

According to another aspect of the present disclosure, there is provided an operation method of a NUMA system, which may include: a page fault occurring for disconnecting a page from the page table; connecting the page to the page table; identifying a state of the page to determine whether the state of the page is changed; decreasing detour value by updating the state of the page when the page's state change is required.

The operation method of a NUMA system may further include increasing detour value by updating the state of the page when the state change of the page is not required.

The operation method of a NUMA system may further include: after the page fault occurred, determining whether the page is shared among threads; determining whether threads sharing the page belong to the same NUMA group; generating a NUMA group and a virtual group between the threads when the threads do not belong to the same NUMA group.

The operation method of a NUMA system may further include setting a target virtual group at memory access when the threads belong to the NUMA group and the virtual group.

The operation method of a NUMA system may further include: after the page fault occurred, determining whether the page is a thread private page; determining whether the page exists in the same position as a thread accessing the page when the page is the thread private page and rearranging the page when the page is not located in the same node that the thread is running; determining whether the page is a system shared page when the page is not the thread private page; moving and rearranging the page to another node to uniformly distribute the number of pages between the nodes when the page is the system shared page.

According to the present disclosure, the operation method of a NUMA system has an advantage in that the execution time and performance deviation of an application that performs multi-thread parallel computing can be improved due to the reduction of the operating system's interference by decreasing unnecessary thread/page rearrangement and by decreasing the number of page faults as compared with the operating system's page profiling.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1 and 2 are flowcharts illustrating a page profiling method of a NUMA system according to the present disclosure;

FIG. 3 is a flowchart illustrating a method for arranging a thread of a NUMA system according to the present disclosure; and

FIG. 4 is a flowchart illustrating a method for arranging a page of a NUMA system according to the present disclosure.

### DETAILED DESCRIPTION OF THE PREFERRED EMBODIMENT

The present disclosure may have various modifications and various exemplary embodiments and specific exemplary embodiments will be illustrated in the drawings and described in detail in the detailed description. However, this does not limit the present disclosure to specific exemplary embodiments, and it should be understood that the present disclosure covers all the modifications, equivalents and replacements included within the idea and technical scope of the present disclosure. In describing each drawing, reference numerals refer to like elements.

Terms including as first, second, A, B, and the like are used for describing various constituent elements, but the constituent elements are not limited by the terms. The terms are used only to discriminate one element from another element. For example, a first component may be referred to as a second component, and similarly, the second component may be referred to as the first component without departing from the scope of the present disclosure. A term and/or includes a combination of a plurality of associated disclosed items or any item of the plurality of associated disclosed items.

It should be understood that, when it is described that a component is “connected to” or “accesses” another component, the component may be directly connected to or access the other component or a third component may be present therebetween. In contrast, when it is described that a component is “directly connected to” or “directly accesses” another component, it is understood that no element is present between the element and another element.

Terms used in the present application are used only to describe specific exemplary embodiments, and are not intended to limit the present disclosure. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

Hereinafter, preferred embodiments of the present disclosure will be described in detail with reference to the accompanying drawings.

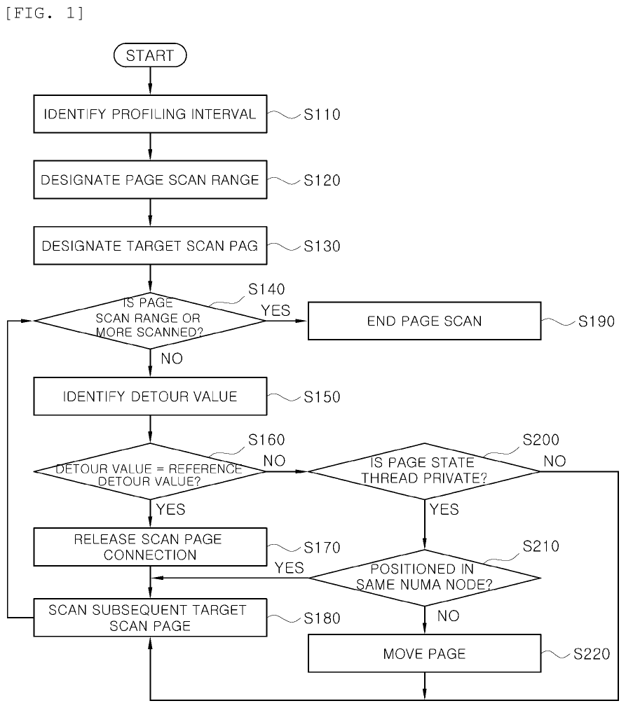

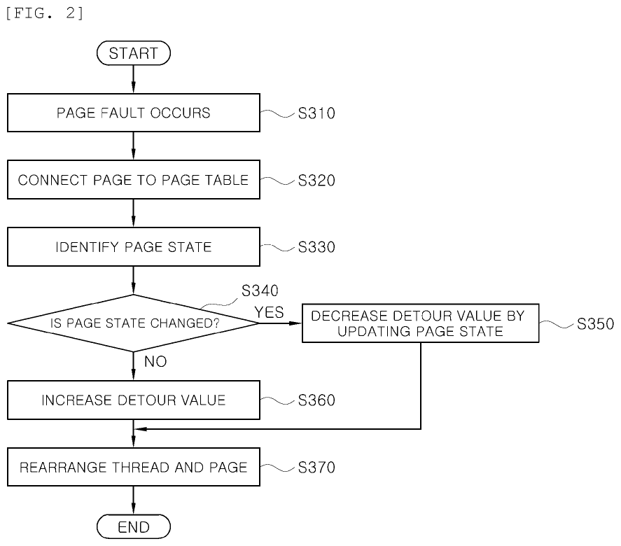

FIGS. 1 and 2 are flowcharts illustrating a page profiling method of a NUMA system according to the present disclosure.

FIG. 1 illustrates a method for releasing a connection of a page from page table for page profiling in which interference of an operating system is minimized in a non-uniform memory access (NUMA) system.

Referring to FIG. 1, a profiling process of the NUMA system may initiate at specific profiling intervals accumulated by a timer interrupt (S110), designate a page scan range (S120), and designate a target scan page for profiling (S130).

That is, the profiling process of the NUMA system may identify the profiling interval for page scan for the profiling and identify whether the timer interrupt currently occurred represents reference time for profiling.

Thereafter, the profiling process of the NUMA system may designate the page scan range, i.e., a scan range for the predefined number of pages, and designate a target scan page which belongs to the page scan range.

The profiling process of the NUMA system may identify whether the page scan range or more is scanned (S140).

In step S140, when the page scan range or more is not scanned, the profiling process of the NUMA system may identify a detour value of a current target scan page (S150).

That is, the detour value of the current target scan page is a value which is varied in response to a state change of the page, and it may be identified whether the page-page table connection should be released according to the detour value.

The profiling process of the NUMA system may determine whether the detour value of the current target scan page is same as a reference detour value (S160).

In step S160, when the detour value of the current target scan page is same as the reference detour value, the profiling process of the NUMA system may release the connection of the current target scan page from the page table (S170).

After releasing the connection of the current target scan page from the page table, the profiling process of the NUMA system may designate a subsequent page of the current target scan page, which is in scan range (S180).

Thereafter, in step S140, when the page scan range or more is scanned, the profiling process of the NUMA system may end the page scan (S190).

In step S160, when the detour value of the current target scan page is not same as the reference detour value, the profiling process of the NUMA system may identify whether a page state is a thread private state in which only one thread is accessed (S200).

In step S200, when the page state is the thread private state, the profiling process of the NUMA system may identify whether the current target scan page and the thread accessing the page privately are positioned in the same NUMA node (S210).

In step S210, when the current target scan page and the thread accessing the page privately are not the same NUMA node, the profiling process of the NUMA system may migrate the current target scan page to a NUMA node in which the thread is executed (S220).

When the page state is not the thread private state in step S200 or when the current target scan page and the thread are the same NUMA node in step S210, the profiling process of the NUMA system may perform step S180.

FIG. 2 illustrates a method for setting a detour value of a scanned page in order to minimize interference of an operating system in a non-uniform memory access (NUMA) system, in which when a page fault occurs, the detour value depending on the page state may be set.

Here, the page fault occurs when the page connection release occurs from the page table as illustrated in FIG. 1, and the thread accesses the corresponding page.

Referring to FIG. 2, in the profiling process of the NUMA system, the page fault may occur (S310), the corresponding page may be connected to the page table (S320), and the state of the corresponding page may be identified (S330).

Thereafter, the profiling process of the NUMA system may determine whether the state of the corresponding page is changed (S340), and decrease the detour value by updating the state of the corresponding page when the state change is required (S350).

In step S340, when the state change is not required, the profiling process of the NUMA system may increase the detour value (S360).

After steps S350 and S360, the profiling process of the NUMA system may rearrange the thread and the page as a result of fault process (S370).

That is, the profiling process of the NUMA system can detect that the state change of the corresponding page is required when the page fault occurs. At this time, the profiling process of the NUMA system may identify that an memory access pattern of the application for the corresponding page is changed.

The profiling process of the NUMA system may modify the state of the page and decrease the detour value when the memory access pattern of the application for the page is changed. Otherwise, when the corresponding page state is not modified, the profiling process of the NUMA system may increase a page scan detour value because the access pattern to the corresponding page is the same as the previous page access scan sequence.

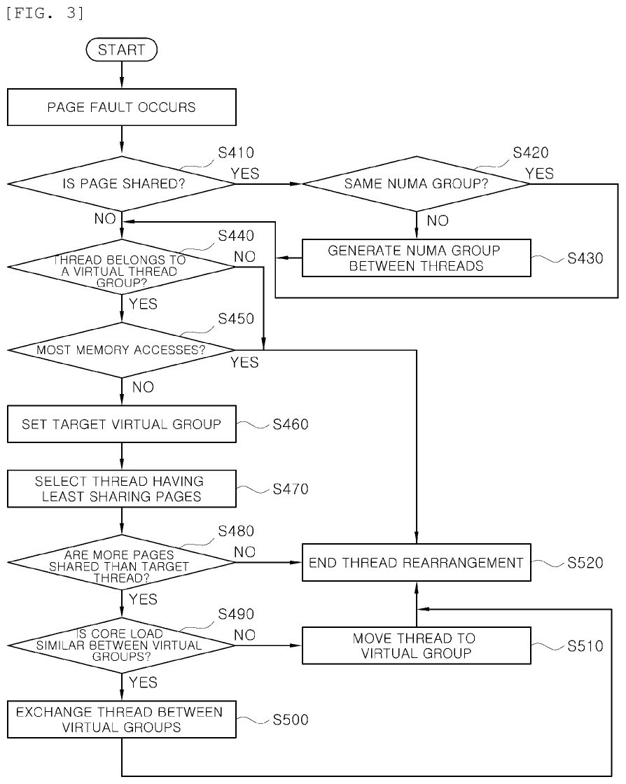

FIG. 3 is a flowchart illustrating a method for arranging a thread of a NUMA system according to the present disclosure.

FIG. 3 illustrates a method for forming a group between threads sharing pages after performing page profiling through the page fault by the profiling process of the NUMA system.

Referring to FIG. 3, the profiling process of the NUMA system may identify whether the corresponding page in which the page fault occurs is shared (S410).

In step S410, when determining that the corresponding page is shared, the profiling process of the NUMA system may determine whether the threads sharing the corresponding page belong to the same NUMA group (S420).

In step S420, when determining that the threads sharing the corresponding page do not belong to the same NUMA group, the profiling process of the NUMA system may generate the NUMA group between the threads (S430).

A NUMA group has virtual thread groups that are the same number as the NUMA nodes in the system, and each NUMA node is connected to a virtual thread group as 1:1. The threads in the NUMA group are included in one virtual thread group connected to a NUMA node that is currently executed.

The corresponding page is not shared in step S410, the threads sharing the corresponding page already belong to the same NUMA group, or the NUMA group and the virtual thread group is generated in step S430, then the profiling process of the NUMA system may determine whether the thread causing the page fault belongs to a virtual thread group (S440).

When the thread causing the page fault belongs to a virtual thread group in step S440, the profiling process of the NUMA system may determine whether the thread performs most memory accesses in the current executing NUMA node (S450).

When not performing most memory accesses in the current executing NUMA node in step S450, the profiling process of the NUMA system may set a virtual thread group connected to the NUMA node in which the thread performs the most memory accesses as a target virtual thread group (S460), and select a thread having least sharing pages in the target virtual thread group as a target thread (S470).

The profiling process of the NUMA system may identify whether the thread causing the page fault shares more pages in the target virtual thread group than the target thread (S480), identify whether core loads of the virtual thread groups are similar when the thread causing the page fault shares more pages than the target thread in the target virtual thread group (S490), and exchange the threads between the virtual thread groups when the core loads are similar (S500).

When the core loads are not similar in step S490, the profiling process of the NUMA system may move the thread causing the page fault to the target virtual thread group from the virtual thread group to which the thread currently belongs (S510).

When the thread does not belong to a virtual thread group in step S440, when the thread performs the most memory accesses in the current executing NUMA node in step S450, when the thread causing the page fault do not share more pages in the target virtual thread group than in the target thread in step S480, the thread is exchanged between the virtual thread groups in step S500, and when the thread is moved from the current virtual thread group to the target virtual thread group in step S510, the profiling process of the NUMA system may end the thread rearrangement (S520).

That is, the profiling process of the NUMA system may form the NUMA group and the virtual thread group between the threads sharing the page, and make a thread that belongs to the NUMA group be included in the virtual thread group connected to the NUMA node which memory is mostly accessed by the thread.

In this case, the profiling process of the NUMA system selects a thread having the smallest number of sharing pages as the target thread in the virtual thread group to compare the number of sharing pages to the thread causing the page fault.

When the thread causing the page fault has more sharing pages in the virtual thread group, the profiling process of the NUMA system performs thread exchange between the groups or thread movement from one virtual thread group to the target virtual thread group according to the core load between the virtual thread groups.

In this case, when the core load is similarly maintained between virtual thread groups in spite of moving the thread to the target virtual thread group, the profiling process of the NUMA system moves the thread to the target virtual thread group. When the core load is similar between the virtual thread groups currently, the profiling process of the NUMA system performs the exchange of the thread between the virtual thread groups.

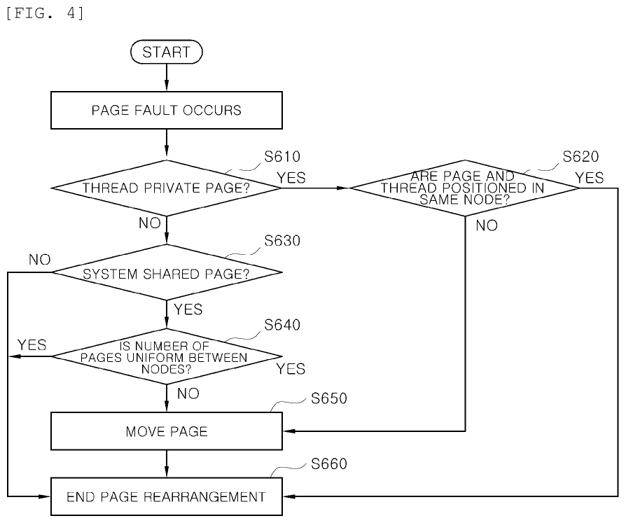

FIG. 4 is a flowchart illustrating a method for arranging a page of a NUMA system according to the present disclosure.

FIG. 4 illustrates a method for performing a different page arrangement policy for each page state after performing page profiling through the page fault by the profiling process of the NUMA system.

Referring to FIG. 4, the profiling process of the NUMA system may identify whether the corresponding page in which the page fault occurs is the thread private page accessed by only one thread (S610).

When the corresponding page is the thread private page in step S610, the profiling process of the NUMA system may identify whether the corresponding page and the thread accessing privately are positioned in the same node (S620).

When the corresponding page is not the thread private page in step S610, the profiling process of the NUMA system may identify whether the corresponding page is a system shared page accessed by multiple NUMA nodes (S630).

When the corresponding page is the system shared page in step S630, the profiling process of the NUMA system may identify whether the number of pages is uniformly distributed among the NUMA nodes (S640).

When the number of pages is not uniformly distributed between the NUMA nodes in step S640 and when the corresponding page and the thread are not positioned in the same node in step S620, the profiling process of the NUMA system may move the corresponding page (S650).

When the corresponding page and the thread are positioned in the same node in step S620, when the corresponding page is not the system shared page in step S630, and when the number of pages is uniformly distributed between the NUMA nodes in step S640, and after step S650, the profiling process of the NUMA system may end the corresponding page rearrangement (S660).

That is, the profiling process of the NUMA system may identify whether the thread accessing the thread private page and the page are located in the same node, and then move the page to the node in which the corresponding thread is executed when the thread and the page are located in different NUMA nodes.

Further, the profiling process of the NUMA system may identify the number of pages for each node if the page is the system shared page, and if the number of pages is not uniformly distributed, the profiling process of the NUMA system may move the corresponding page to a node at which a small number of pages are positioned in order to uniformly distribute the number of pages.

Features, structures, effects, and the like described in the above exemplary embodiments are included in at least one embodiment of the present disclosure, and are not particularly limited to only one exemplary embodiment. Furthermore, features, structures, effects, and the like exemplified in each embodiment may be combined or modified for other exemplary embodiments those skilled in the art to which the exemplary embodiments pertain. Therefore, the contents related to such combinations and modifications should be interpreted as being included in the scope of the present disclosure.

In addition, although the exemplary embodiments have been mainly described above, these are merely examples and do not limit the present disclosure, and those skilled in the art to which the present disclosure pertains will know that various modifications and applications not illustrated above may be made within the scope without departing from the essential characteristics of the exemplary embodiment. For example, each component specifically shown in the exemplary embodiment may be implemented by being modified. In addition, it will be interpreted that differences related to the modifications and applications are included in the scope of the present disclosure defined in the appended claims.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present invention. The protective scope of the present disclosure should be construed based on the following claims, and all the technical concepts in the equivalent scope thereof should be construed as falling within the scope of the present disclosure.

What is claimed is:

1. An operation method of a NUMA system, comprising:
designating a page scan range including a plurality of pages;
identifying a detour value for each of the plurality of pages;
determining whether a detour value of a current target scan page is the same as the reference detour value; and
releasing a connection of the current target scan page from a page table when determining that the detour value of the current target scan page is the same as the reference detour value.

2. The operation method of a NUMA system of claim 1, further comprising:
before identifying the detour value,
determining whether the page scan range or more is scanned.

3. The operation method of a NUMA system of claim 2, wherein when the current target scan page is scanned less than the page scan range,
in the identifying of the detour value,
the detour value of the current target scan page is identified, which increases or decreases according to whether a state determined by an access pattern of threads is changed.

4. The operation method of a NUMA system of claim 1, further comprising:
after releasing a connection of the target page from the page table,
scanning a subsequent target scan page of the current target scan page.

5. The operation method of a NUMA system of claim 1, further comprising:
when the detour value is not the same as the reference detour value,
determining whether the page state of the current target scan page is a thread private state accessed only by one thread.

6. The operation method of a NUMA system of claim 5, further comprising:
when the page state is the thread private state,
determining whether the current target scan page and the thread accessing the page privately are positioned in the same NUMA node; and
moving the current target scan page to a NUMA node in which the thread is executed when the current target scan page and the thread are not positioned in the same NUMA node.

7. An operation method of a NUMA system, comprising:
a page fault occurring for a page of which connection is released from the page table;
connecting the page to the page table;
identifying a state of the page to determine whether the state of the page is changed; and
decreasing a detour value by updating the state of the page when the state change of the page is required.

8. The operation method of a NUMA system of claim 7, further comprising:
when the state change of the page is not required,
increasing a detour value by updating the state of the page.

9. The operation method of a NUMA system of claim 7, further comprising:
after the page fault occurring,
determining whether the page is shared;
determining whether threads sharing the page belong to the same NUMA group when determining that the page is shared; and
generating a NUMA group and a virtual thread group between the threads when the threads do not belong to the same NUMA group.

10. The operation method of a NUMA system of claim 9, further comprising:
when the thread belongs to the NUMA group and the virtual thread group,
setting a target virtual group when performing a memory access in an executing NUMA node.

11. The operation method of a NUMA system of claim 7, further comprising:
after the page fault occurring,
determining whether the page is a thread private page;
determining whether the page exists in the same executing NUMA node as a thread accessing the page when the page is the thread private page and rearranging the page when the page is not located in the same NUMA node that the thread is executing;
determining whether the page is a system shared page when the page is not the thread private page; and
moving and rearranging the page to another node according to the number of pages is uniformly distributed between the NUMA nodes when the page is the system shared page.
